(19) United States
(12) Patent Application Publication
(10) Pub. No.: US 2020/0400290 A1
(43) Pub. Date: Dec. 24, 2020

(54) Pack Lamp

(71) Applicant: Randy Harris, Huntsville, UT (US)

(72) Inventor: Randy Harris, Huntsville, UT (US)

(21) Appl. No.: 16/447,960

(22) Filed: Jun. 21, 2019

(51) Int. Cl. F21V 21/088; F21L 4/08; F21V 23/04

(52) U.S. Cl. CPC F21V 21/0885; F21Y 2115/10; F21V 23/0414; F21L 4/085

(57) ABSTRACT

A lamp providing hands free illumination. The lamp includes a strap attachment for attaching the lamp to a backpack strap or other wearable webbing. The lamp body having a power source mounted within the body, with a LED light source exposed on a surface of the body, a power switch button mounted to the body to control the LED light source. The lamp with a hinge to pivot the lamp up and down to direct the light in front of the user.

### FIELD OF THE INVENTION

The present invention relates to a lamp assembly and more particularly to a lamp assembly that clamps to a backpack shoulder strap for hands free illumination.

### BACKGROUND

There are many situations where some sort of hands-free illumination is required to travel safely in the dark. Some scenarios might include a hunter or backpacker hiking in the dark. Other scenarios may include students leaving class in the dark or walking to or from a bus stop in the dark, often carrying items in their hands while walking. It is common in most of these scenarios for the person to be wearing some sort of backpack and to be carrying something in their hands while walking. These scenarios may require some type of hands-free illumination device to be safe. There are many options for illumination devices, but not all of them are convenient or readily available when needed.

Flashlights are a common option while hiking, but are inconvenient because they require one or more hands to hold and point while using. Flashlights are not always readily available when needed and typically need to be stored when done using them, as they are not convenient to have around when not in use.

Headlamps are commonly used but may be uncomfortable when worn on your head when hiking in warm weather. If the person wears a hat, headlamps may require adjustment to fit comfortably or may not be practical to wear at all. Headlamps might not be readily available since they are not always convenient to keep accessible when not in use.

Some clip light designs provide attachment to articles of clothing or headgear but are not always convenient to leave in place while not in use. Some clip light designs do not stay locked in place and can move, slip or dislodge if bumped.

A headlamp, flashlight or clip light may have unique uses for specific applications. Most of these illumination options are not practical to leave in place when not in use.

### SUMMARY OF THE INVENTION

The present invention solves the problems of the prior art with a lamp that is attachable to a backpack shoulder strap and can be left in place when not in use. The present invention comprises a clamp on the body of lamp that can be secured to items such as backpack shoulder strap, webbing attached to the backpack shoulder strap, fishing wader straps or other wearable devices with webbing. The clamp can lock onto the webbing or strap and can remain attached even when the lamp is not in use. The lamp can pivot up and down to direct the illumination at different angles in front of the user.

One aspect includes a light comprising a lamp having a power source mounted within the lamp body, an LED light source coupled to the lamp with a rotatable housing for adjusting the direction of illumination, and a switch mounted to the lamp body for controlling an electrical connection between the power source and the LED light source.

### BRIEF DESCRIPTION OF THE DRAWING

FIG. 1 shows a perspective view of a lamp, with the strap attachment clamp panel in the open position according to one embodiment of the present invention.

FIG. 2 is a lengthwise section view through the center of the lamp body, through the center of the LED light source of the lamp of FIG. 1 showing the strap attachment clamp panel in the closed position.

FIG. 3 is a widthwise section view through the center of the lamp body, through the center of the LED light source of the lamp of FIG. 1 showing the strap attachment clamp panel in the closed position.

FIG. 4 is a side perspective view of the lamp rotated 90° from the view of FIG. 1 with the strap attachment clamp panel in the open position.

FIG. 5 is an exploded assembly view of the lamp of FIG. 1 showing the lamp body disconnected from the strap attachment, the optical lens, batteries, end cap, and the end components.

FIG. 6 is a front perspective view of the lamp of FIG. 1 showing the lamp clamped to a piece of webbing.

FIG. 7 is a front view of the lamp of FIG. 1 showing the lamp clamped to the webbing on a shoulder strap of a backpack on a person.

FIG. 8 is a side perspective view of the lamp of FIG. 1 showing the lamp pivoted down away from the strap attachment clamp panel.

FIG. 9 is a top back view of the lamp of FIG. 1 showing the strap attachment clamp panel in the closed position, with the lamp pivoted down.

FIG. 10 is a top view of the lamp of FIG. 1 showing a section view of a backpack shoulder strap strapped to the strap attachment clamp panel with the clamp in the open position.

FIG. 11 is a perspective view of the lamp of FIG. 1 showing the lamp clamped to a shoulder strap of a backpack that has no webbing attached to the shoulder strap. The strap attachment is shown clamped in the closed position.

FIG. 12 is a front view of the lamp of FIG. 1 showing the lamp clamped to a shoulder strap of a backpack on the person.

### DETAILED DESCRIPTION OF THE INVENTION

In the following description, various aspects of the present invention will be described. It is to be understood that the embodiments of the invention herein described are merely illustrative of the application of the principles of the invention. These embodiments are described in sufficient detail to enable those skilled in the art to practice the invention. Reference herein to details of the illustrated embodiments is not intended to limit the scope of the claims. Therefore, the following detailed description is not to be taken in a limiting sense, and the scope of the present invention is defined by the appended claims and their equivalents.

FIG. 1 shows a perspective view of a lamp with the lamp body 100 attached to the strap attachment 120 with a strap attachment clamp panel 122 in the open position. The Pack Lamp generally includes a lamp body 100, a light emitting diode (LED) light source 106, and a power switch button 102. An example lamp body 100 includes a plastic shell body and is a low profile, small form factor to be unobtrusive and minimal in size. The main lamp body is generally in a flat rectangular configuration with rounded edges. The LED light source external housing 103 rises to the edge of the glare shield 104 covering the optical lens 101. FIG. 1 shows one side of the main lamp with the power switch button 102 and end cap assembly 109 secured in place to the lamp body 100.

The main lamp body has dimensions of approximately 2.125 inches long, 1.375 inches wide, and 1.4 inch thick. The LED light source 106 projects from the lamp body 100 such that the light projects from the front surface of the lamp body. The LED light is typically a white LED but can be comprised of different colored LED's.

The power switch button 102 can also be used to reduce power to the LED light source in multiple increments of decreased power and thus, less light output by pressing multiple times on the power switch cycling back to full power and power off.

The strap attachment back panel 121 connects to the strap attachment clamp panel 122 through a pinned strap attachment hinge 123 to allow the strap attachment clamp panel to swing freely when unclamped. The length and width of the strap attachment 120 components are roughly similar to the lamp body 100. The thickness of the strap attachment 120 is approximately 0.5 inches when closed. The strap attachment components are made of plastic.

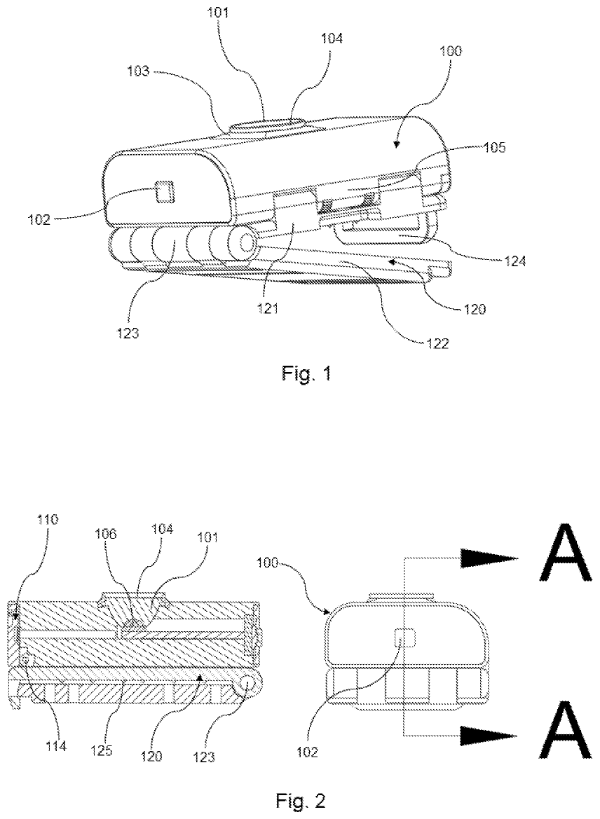

FIG. 2 shows a length wise cross-section side view of a portion of lamp body 100, with the strap attachment 120 in the closed position. FIG. 2 shows the optical lens 101 and LED light source 106 and a cross section of the battery cover module 110. Surrounding the optical lens 101 is a glare shield 104 to reduce the amount of light reflected into the users' eyes. The optical lens 101 may support various light beam angles and focus. The optical lens 101 and LED light source 106 are imbedded inside the lamp body 100, between the batteries 140 shown in FIG. 2. and held in place by the light source external housing 103. The light source external housing 103 protrudes slightly from the lamp body surface to provide a low profile.

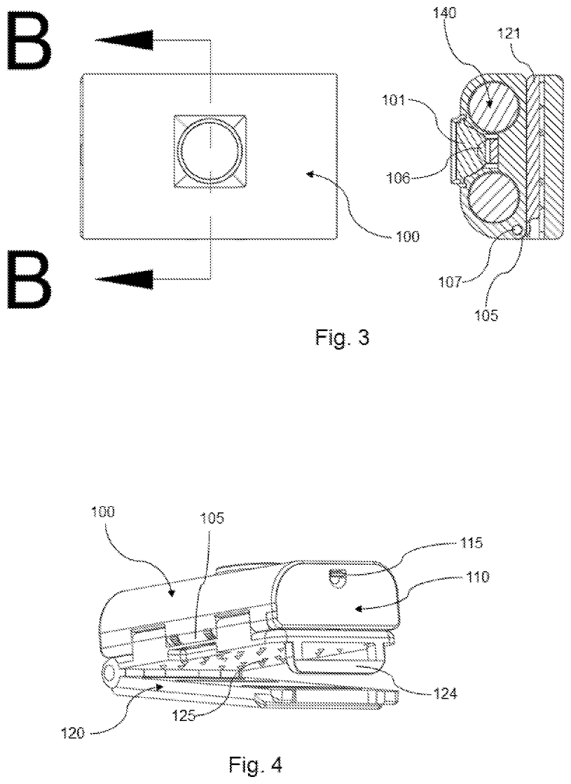

FIG. 3 shows a width wise cross section view of the lamp body 100 with the strap attachment in the closed position. FIG. 3 shows a cross section of the power sources 140 140 (in this example, two AAA batteries) mounted therein on opposite sides of the optical lens 101 and the LED light source 106. This section view also shows the lamp hinge pin 107 that the lamp hinge 105 can pivot on to rotate the lamp body 100 down and away from the strap attachment back panel 121.

FIG. 4 shows a perspective view of the lamp body 100 showing the battery cover 110 and the battery cover release clip 115 with the strap attachment 120 in the open position. The battery cover 110 can be unlatched from the lamp body 100 by pressing the battery cover release clip 115 to access the batteries 140 in the main lamp body. FIG. 4 also shows the multiple clamp teeth 125 which cover the inside surface of the strap attachment back panel 121 to provide a secure connection to various strap material thicknesses to prevent slipping when locked shut.

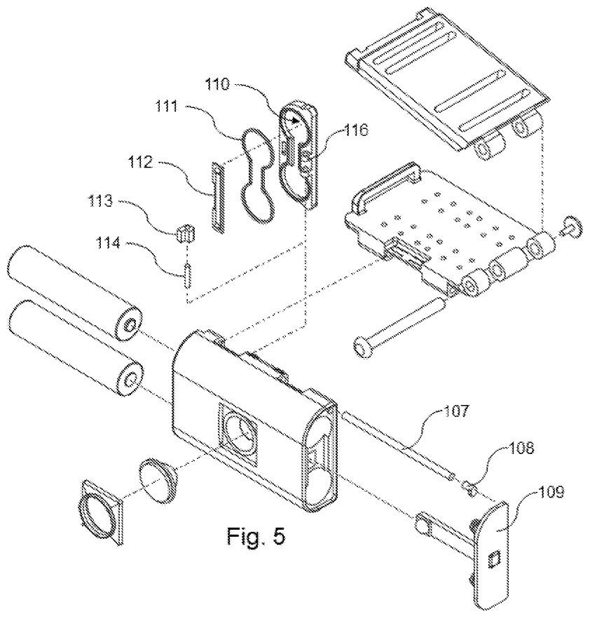

FIG. 5 shows an exploded assembly view of the lamp body 100 components. At the bottom right is the end cap assembly 109 which includes an end cap with a power switch button 102 in the middle of the end cap, two electrically connected battery springs on each end of the end cap and a printed circuit board (PCB) protruding from the end cap towards the lamp with the LED light source 106, which is attached to the end of the PCB. The end cap assembly 109 is permanently secured to the lamp body 100 to seal this end of the lamp body 100. The hinge pin 107 is retained in the lamp body 100 by the hinge pin retainer 108 to provide a seal from outside moisture entering from the hinge pin 107.

FIG. 5 also shows an exploded view of the battery cover 110 components. The battery cover contains a battery cover seal ring 111 that fits into a groove in the battery cover 110. The battery cover 110 has a battery cover contact 112 that makes an electrical connection between the batteries 140. The battery cover hinge adapter 113 is secured to the lamp body 100, and has a battery cover hinge pin 114 that connects the battery cover hinge adapter 113 to the battery cover hinge 116.

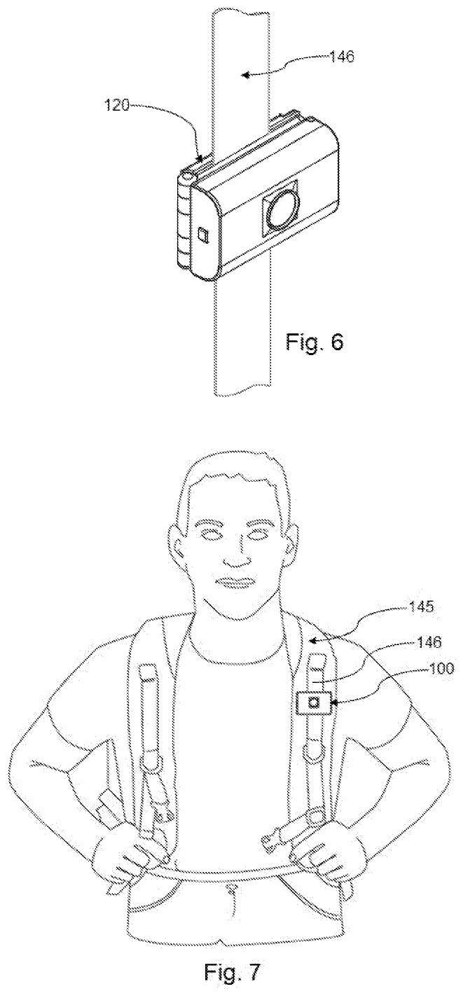

FIG. 6 shows the lamp attached to a piece of webbing 146 with the strap attachment 120 clamped and locked on the webbing 146. The strap or webbing 146 can be of variable widths (from approximately 0.25 to 1.8 inches wide) and thicknesses (from approximately 0.020-0.050 inches thick) typical of straps or webbing found on many commercial backpacks, fishing waders or other wearable devices with webbing.

FIG. 7 shows an example of the lamp 100 clamped onto a backpack strap webbing 146 which is attached to the shoulder strap 145 of a backpack the user is wearing. Many backpacks have shoulder straps with webbing integrated into the shoulder strap.

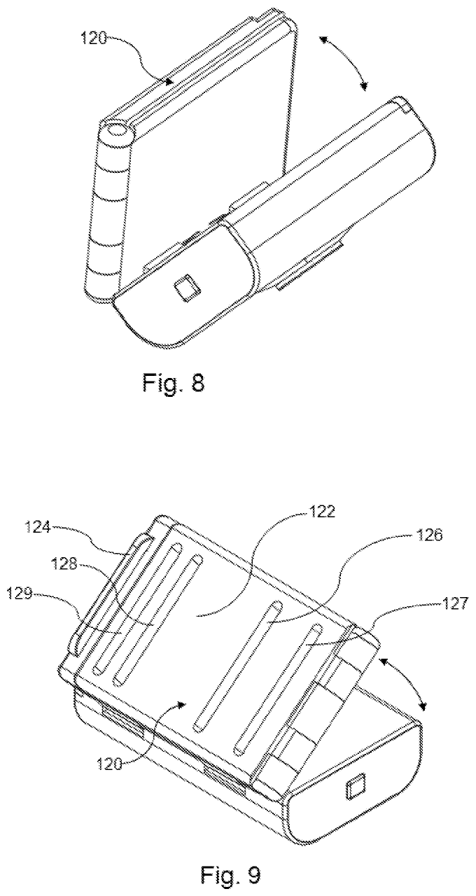

FIG. 8 shows an example of the lamp body 100 pivoted down and away from the strap attachment 120. The lamp 100 can pivot down approximately 90 degrees from the starting position against the strap attachment 120.

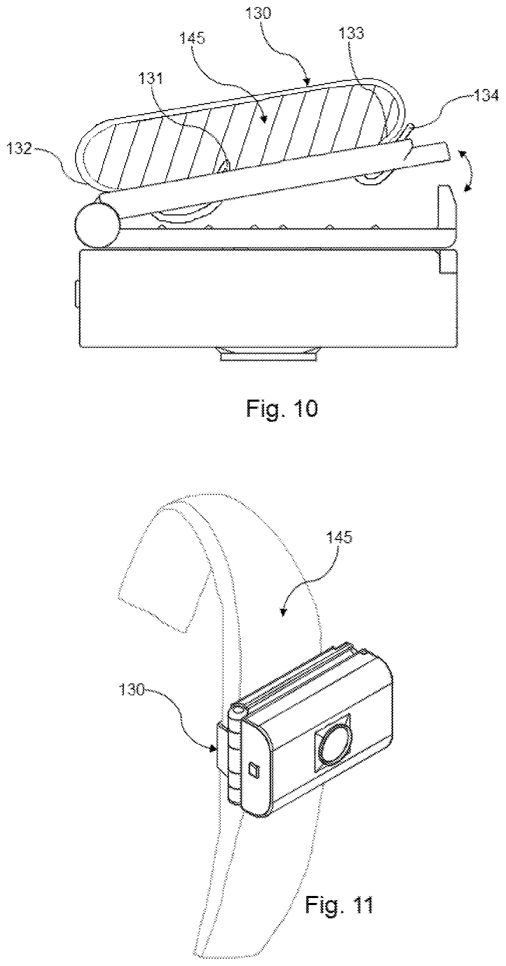

FIG. 9 and FIG. 10 shows the multiple slots in the strap attachment clamp panel 122 that provide an alternative method of attaching the lamp 100 to a backpack shoulder strap 145 or other wearable devices that do not have an integrated piece of webbing to clamp to. The four slots are used to weave a piece of approximately 0.75-inch-wide strap webbing 130 through and around a thicker strap such as a backpack shoulder strap 145 as shown in FIG. 10. The strap webbing 130 shown in FIG. 10 passes through the clamp panel 1^{st} slot 126 from the backside. The strap webbing 130 contains a small fold forming a loop at the strap webbing looped end 131, with the loop secured together by sewing or other means, so the end of the strap is too wide to pass all the way through the clamp panel 1^{st} slot 126 so that the strap webbing 130 stops at the looped end of the webbing when pulled through the clamp panel 1^{st} slot 126. Next, the strap webbing 130 passes through clamp panel 2^{nd} slot 127 and is pulled tight at 132. The webbing then loops around the backpack shoulder strap 145 as shown in FIG. 10. With the webbing pulled tight around the backpack shoulder strap 145 it next goes through the clamp panel 3^{rd} slot 128 from the backside, making a tight turn, and finishes by passing through the clamp panel 4^{th} slot 129. With the webbing 130 pulled tight 133 and pulled tight at 134, the strap attachment clamp panel 122 is closed shut, clamping the strap webbing 130 in place with the strap attachment clamp lock bracket 124 locking into the strap attachment back panel 121, pressing the strap attachment clamp panel 122 and strap attachment back panel 121 together, securing the webbing 130 in place.

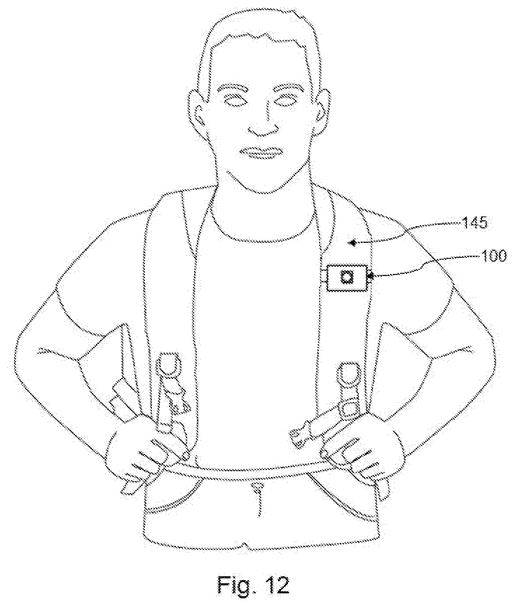

FIG. 11 shows the lamp 100 secured to a backpack shoulder strap 145 with the strap webbing 130 secured around the backpack shoulder strap 145. FIG. 12 shows an example of a person wearing a backpack with a backpack shoulder strap 145 without integrated webbing 146, with the lamp clamped onto the backpack shoulder strap 145 with the strap webbing 130 secured as described in FIG. 11.

What is claimed is:

1. A lamp, comprising:
a. a LED light source;
b. a lamp body having a power source mounted therein, the lamp body being a generally rectangular body having a top surface, a pair of opposing side surfaces, and a front surface;
c. a LED light source coupled to the lamp body and connectable to the power source, wherein the LED light source is positioned so that the illumination is exposed on the front surface of the lamp body;
d. a power switch button mounted to the side surface of the lamp body, the switch for controlling an electrical connection between the LED light source and the power source; and,
e. a strap attachment member for securing the lamp body to a backpack shoulder strap or other wearable webbing.

2. The strap attachment member recited in claim 1, further comprising a strap attachment back panel, a strap attachment hinge, a strap attachment clamp panel, a strap attachment clamp lock bracket for clamping the strap attachment member to a piece of webbing.

3. The strap attachment member recited in claim 1, further comprising multiple slots through the strap attachment clamp panel to feed webbing through the multiple slots and around a backpack shoulder strap, clamping the strap attachment clamp panel over the webbing to secure the strap attachment to a backpack shoulder strap.

4. The LED light source recited in claim 1, further comprising an optical lens mounted over the LED light source facing the front of the lamp body, with a with the optical lens held in place with a LED light source external housing, with a glare shield surrounding the outer edges of the optical lens.

5. The lamp body recited in claim 1, wherein the power source includes two AAA or AA batteries, with the LED light source and optical lens situated between the two batteries.

6. The lamp body recited in claim 1, wherein the lamp body can pivot up and down from a hinge on the strap attachment.
